(19) United States
(12) Patent Application Publication
(10) Pub. No.: US 2023/0131387 A1
(43) Pub. Date: Apr. 27, 2023

(54) TOW MANAGEMENT SYSTEMS AND METHODS FOR AUTONOMOUS VEHICLES

(71) Applicant: GM GLOBAL TECHNOLOGY OPERATIONS LLC, Detroit, MI (US)

(72) Inventors: Rasoul Salehi, Ann Arbor, MI (US); Arun Adiththan, Sterling Heights, MI (US); Yao Hu, Sterling Heights, MI (US); Yilu Zhang, Northville, MI (US)

(73) Assignee: GM GLOBAL TECHNOLOGY OPERATIONS LLC, Detroit, MI (US)

(21) Appl. No.: 17/452,301

(22) Filed: Oct. 26, 2021

(51) Int. Cl. G08G 1/00; G07C 5/08; G07C 5/00; G05D 1/02; G05D 1/10

(52) U.S. Cl. CPC G08G 1/22; G08G 1/202; G08G 1/205; G07C 5/0808; G07C 5/008; G05D 1/0291; G05D 1/104

(57) ABSTRACT

Methods and systems for a remote transportation system including a first autonomous vehicle, at least one second autonomous vehicle and a remote transportation server are provided. The server includes non-transitory computer readable media and one or more processors configured by programming instructions on the non-transitory computer readable media to: receive a request for tow service from the first vehicle, wherein the request includes a location of the first autonomous vehicle; identify a towing destination for the first autonomous vehicle based on the location of the first autonomous vehicle; perform an initial fault diagnosis to determine a towing type; confirm the towing type with the first autonomous vehicle to be at least one of a ground tow, an aerial tow, and a sensor kit tow; and coordinate towing of the first autonomous vehicle to the towing destination by the at least one second autonomous vehicle based on the towing type.

### TECHNICAL FIELD

The technology described in this patent document relates generally to towing of autonomous vehicles, and more particularly to systems and methods for towing autonomous vehicles using an autonomous vehicle.

An autonomous vehicle is a vehicle that can sense its environment and navigating with little or no user input. An autonomous vehicle senses its environment using sensing devices such as radar, lidar, image sensors, and the like. The autonomous vehicle system further uses information from a positioning system including global positioning systems (GPS) technology, navigation systems, vehicle-to-vehicle communication, vehicle-to-infrastructure technology, and/or drive-by-wire systems to navigate the vehicle.

In some instances, an autonomous vehicle may be unable to continue driving due to, for example, a fault in one or more systems of the vehicle. In such cases, it may be desirable to tow the autonomous vehicle to a location where the fault can be evaluated and/or repaired. It is desirable to have another autonomous vehicle tow the faulty autonomous vehicle.

Accordingly, it is desirable to provide systems and methods for managing the towing of autonomous vehicles using an autonomous vehicle. Furthermore, other desirable features and characteristics will become apparent from the subsequent detailed description and the appended claims, taken in conjunction with the accompanying drawings.

### SUMMARY

Methods and systems for a transportation system including a first autonomous vehicle, at least one second autonomous vehicle and a remote transportation server are provided. The remote transportation server includes non-transitory computer readable media and one or more processors configured by programming instructions on the non-transitory computer readable media to: receive a request for tow service from the first vehicle, wherein the request includes a location of the first autonomous vehicle; identify a towing destination for the first autonomous vehicle based on the location of the first autonomous vehicle; perform an initial fault diagnosis to determine a towing type; confirm the towing type with the first autonomous vehicle to be at least one of a ground tow, an aerial tow, and a sensor kit tow; and coordinate towing of the first autonomous vehicle to the towing destination by the at least one second autonomous vehicle based on the towing type.

In various embodiments, the towing type is a ground tow platoon.

In various embodiments, the towing type is an aerial tow platoon.

In various embodiments, the instructions confirm the towing type based on towing options communicated by the first autonomous vehicle.

In various embodiments, the instructions confirm the towing type based on a determination of operation of an aerial autonomous vehicle in the environment of the first autonomous vehicle.

In various embodiments, the instructions coordinate the towing based on an availability of the at least one second autonomous vehicle. In various embodiments, the instructions are further configured to coordinate the towing of the first autonomous vehicle by the at least one second autonomous vehicle.

In various embodiments, the instructions are further configured to coordinate reformation of at least one of a ground tow platoon or an aerial tow platoon based on the monitoring.

In various embodiments, the instructions are further configured to coordinate exit of the first autonomous vehicle from the tow based on the monitoring.

In various embodiments, the instructions are further configured to communicate to objects surrounding the first autonomous vehicle an indication of the tow.

In another embodiment, a method in a transportation system including a first autonomous vehicle, at least one second autonomous vehicle and a remote transportation server includes: receiving a request for tow service from the first vehicle, wherein the request includes a location of the first autonomous vehicle; identifying a towing destination for the first autonomous vehicle based on the location of the first autonomous vehicle; performing an initial fault diagnosis to determine a towing type; confirming the towing type with the first autonomous vehicle to be at least one of a ground tow, an aerial tow, and a sensor kit tow; and coordinating towing of the first autonomous vehicle to the towing destination by the at least one second autonomous vehicle based on the towing type.

In various embodiments, the towing type is a ground tow platoon.

In various embodiments, the towing type is an aerial tow platoon.

In various embodiments, the confirming the towing type is based on towing options communicated by the first autonomous vehicle.

In various embodiments, the confirming the towing type is based on a determination of operation of an aerial autonomous vehicle in the environment of the first autonomous vehicle.

In various embodiments, the coordinating the towing is based on an availability of the at least one second autonomous vehicle.

In various embodiments, the method includes coordinating the towing of the first autonomous vehicle by the at least one second autonomous vehicle.

In various embodiments, the method includes comprising coordinating reformation of at least one of a ground tow platoon or an aerial tow platoon based on the monitoring.

In various embodiments, the method includes coordinating exit of the first autonomous vehicle from the tow based on the monitoring.

In various embodiments, the method includes communicating to objects surrounding the first autonomous vehicle an indication of the tow.

### BRIEF DESCRIPTION OF THE DRAWINGS

The exemplary embodiments will hereinafter be described in conjunction with the following drawing figures, wherein like numerals denote like elements, and wherein:

FIG. 1 is a block diagram illustrating an example transportation system for providing towing services, in accordance with various embodiments;

FIG. 2 is a block diagram illustrating an example autonomous vehicle that may be used in the example transportation system as a towing vehicle or a towed vehicle, in accordance with various embodiments; and

FIGS. 3, 4, 5, 6, and 7 are flowcharts illustrating methods performed by one or more elements of the transportation system in response to a request for towing services, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques, and articles for a transportation system that enables management methods, systems, and interactions of the transportation system and a host vehicle (e.g., a faulty vehicle equipped for autonomous towing) to initiate, plan, coordinate, monitor, and end a tow process with an autonomous vehicle. In various embodiments, the transportation system is a back-office type transportation system that includes a remote host vehicle and a remote tow vehicle. In various embodiments, the host vehicle is an autonomous vehicle.

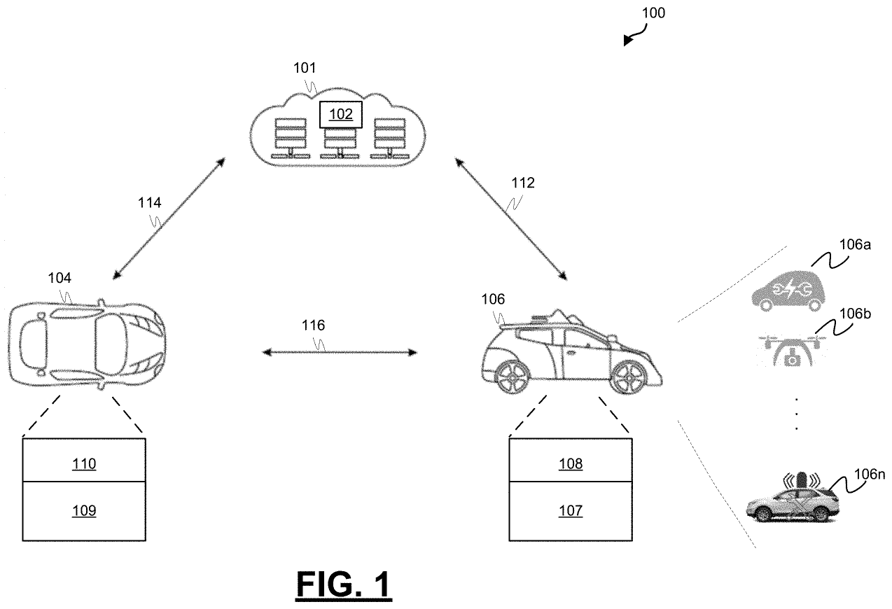

With refence now to FIG. 1, a functional block diagram illustrates an example transportation system 100 in accordance with various embodiments. In various embodiments, the transportation system 100 includes a towing service module 102 (e.g., that resides on a server), one or more autonomous vehicles 104, and one or more towing vehicles 106. The towing vehicles 106 can include, but are not limited to ground based autonomous vehicles 106a, aerial autonomous vehicles 106b, and sensor kits 106n. In general, the transportation system 100 enables a towing service with programmed modules, sensors, and communication systems that enable one or more of the autonomous vehicles 104 to be towed by one of the towing vehicles 106a-106n.

For example, the towing service allows for fully autonomous equipped vehicles or sensor kits that enable autonomous operation to extend their autonomous driving capabilities to other autonomous vehicles that may be unable to operate due to a fault. In various embodiments, the autonomous vehicle 106 (whether it be a full vehicle or a sensor kit) is configured with at least one controller 107 that includes a towing module 108 that controls the autonomous vehicle 106 to lead the autonomous vehicle 104 to a location that, for example, may service the fault of the autonomous vehicle. The leading can be by way of providing control commands for the autonomous vehicle 104 to follow or by way of providing sensed data or perception data for the autonomous vehicle to evaluate when determining towing commands, and/or by providing a combination of control commands and sensed/perception data.

The autonomous vehicle 104 is configured with at least one controller 109 that includes a towing module 110 that controls the autonomous vehicle 104 to relinquish all or parts of driving control to the vehicle 106 for the trip to the service location by following the vehicle 106 and/or following the commands or sensor data of the sensor kit.

In various embodiments, the vehicle 106 is communicatively coupled to the towing service module 102 via a communication link 112, and the autonomous vehicle 104 is communicatively coupled to the towing service module 102 via a communication link 114. Through the communication links 112, 114, the towing service module 102 can facilitate setup of a tow between the autonomous vehicle 106 and the autonomous vehicle 104, monitor the tow procedure, communicate status information regarding the tow procedure to each other, communicate tow termination requests between the autonomous vehicles 104, 106, communicate safety and security information between the autonomous vehicles 104, 106, as well as other tasks to enable an effective towing service.

In various embodiments, the autonomous vehicle 106 is dynamically coupled to the autonomous vehicle 104 via a virtual link 116. The virtual link 116 is established when a need for towing has been identified and the autonomous vehicle 104 is in proximity to the autonomous vehicle 106. In various embodiments, the virtual link 116 and the communication links 112, 114, may be implemented using a wireless carrier system such as a cellular telephone system and/or a satellite communication system. The wireless carrier system can implement any suitable communications technology, including, for example, digital technologies such as CDMA (e.g., CDMA2000), LTE (e.g., 4G LTE or 5G LTE), GSM/GPRS, or other current or emerging wireless technologies.

The communication links 112, 114, may also be implemented using a conventional land-based telecommunications network coupled to the wireless carrier system. For example, the land communication system may include a public switched telephone network (PSTN) such as that used to provide hardwired telephony, packet-switched data communications, and the Internet infrastructure. One or more segments of the land communication system can be implemented using a standard wired network, a fiber or other optical network, a cable network, power lines, other wireless networks such as wireless local area networks (WLANs), or networks providing broadband wireless access (BWA), or any combination thereof.

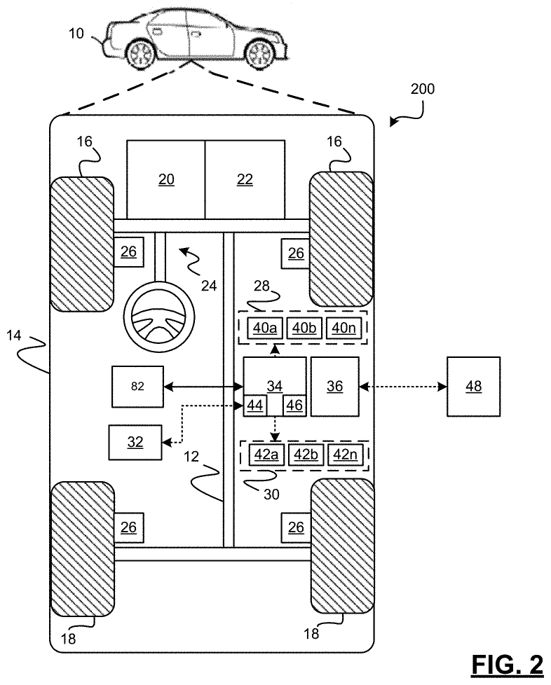

Referring now to FIG. 2, a block diagram illustrates an example vehicle 200 that may be used in the example transportation system 100 as either the autonomous vehicle 106 or the autonomous vehicle 104. The example vehicle 200 generally includes a chassis 12, a body 14, front wheels 16, and rear wheels 18. The body 14 is arranged on the chassis 12 and substantially encloses components of the vehicle 200. The body 14 and the chassis 12 may jointly form a frame. The wheels 16-18 are each rotationally coupled to the chassis 12 near a respective corner of the body 14. The vehicle 200 is depicted in the illustrated embodiment as a passenger car, but other vehicle types, including trucks, sport utility vehicles (SUVs), recreational vehicles (RVs), etc., may also be used.

The vehicle 200 may be capable of level Four or Five automation. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

In various embodiments, the vehicle 200 further includes a propulsion system 20, a transmission system 22 to transmit power from the propulsion system 20 to vehicle wheels 16-18, a steering system 24 to influence the position of the vehicle wheels 16-18, a brake system 26 to provide braking torque to the vehicle wheels 16-18, a sensor system 28, an actuator system 30, at least one data storage device 32, at least one controller 34, a communication system 36 that is configured to wirelessly communicate information to and from other entities 48, such as the other vehicle 104, 106 and the towing service module 102, and a notification device 82 that generates visual, audio, and/or haptic notifications to users in proximity to the vehicle 200.

The sensor system 28 includes one or more sensing devices 40a-40n that sense observable conditions of the exterior environment and/or the interior environment of the autonomous vehicle 10. The sensing devices 40a-40n can include, depending on the level of autonomy of the vehicle 200, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26.

The communication system 36 is configured to wirelessly communicate information to and from the other entities 48, such as but not limited to, other vehicles (“V2V” communication,) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the vehicle 200. The data storage device 32 may be part of the controller 34, separate from the controller 34, or part of the controller 34 and part of a separate system. The controller 34 includes at least one processor 44 and a computer-readable storage device or media 46. Although only one controller 34 is shown in FIG. 2, embodiments of the vehicle 200 may include any number of controllers 34 that communicate over any suitable communication medium or a combination of communication mediums and that cooperate to process the sensor signals, perform logic, calculations, methods, and/or algorithms, and generate control signals to automatically control features of the vehicle 200.

The processor 44 can be any custom made or commercially available processor, a central processing unit (CPU), a graphics processing unit (GPU), an auxiliary processor among several processors associated with the controller 34, a semiconductor-based microprocessor (in the form of a microchip or chipset), a macro processor, any combination thereof, or generally any device for executing instructions. The computer-readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of several known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34.

The programming instructions may include one or more separate programs, each of which comprises an ordered listing of executable instructions for implementing logical functions. In various embodiments, the instructions may be implemented in the towing module 108 (FIG. 1) or the towing module 110 (FIG. 1). The instructions, when executed by the processor, perform towing functions of the vehicles 104, 106 as will be discussed in more detail below.

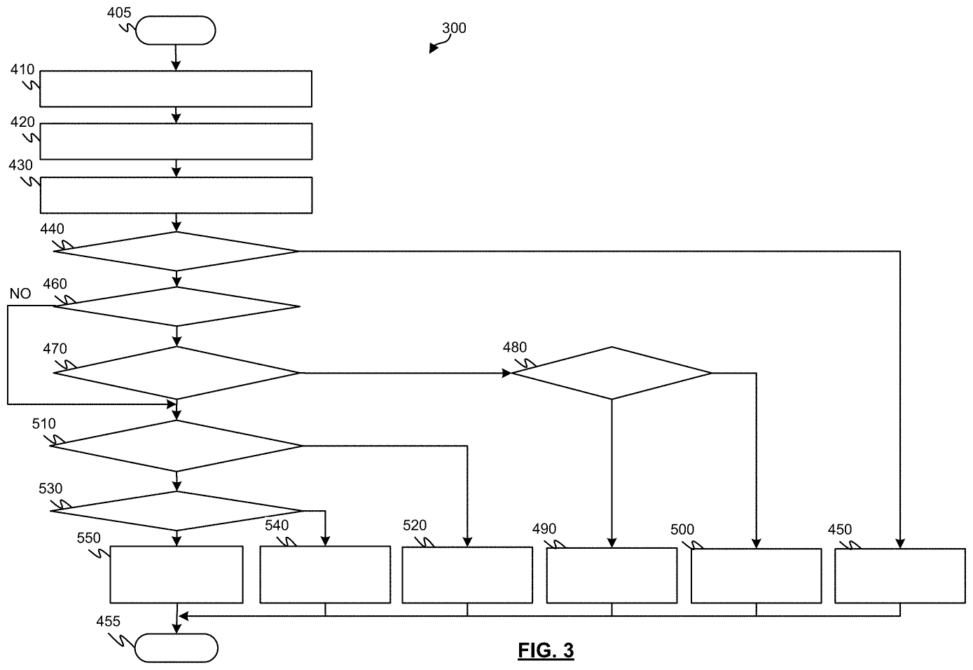

Referring now to FIGS. 3-7 and with continued reference to FIGS. 1-2, flowcharts illustrate control methods 300, 600, 700, 900, and 1000 that can be performed by system 100 of FIG. 1, and more particularly by the towing service module 102, the towing module 110 and/or the towing module 108 in accordance with the present disclosure. As can be appreciated in light of the disclosure, the order of operation within the control methods 300, 600, 700, 900, and 1000 is not limited to the sequential execution as illustrated in FIG. 3-7 but may be performed in one or more varying orders as applicable and in accordance with the present disclosure. In various embodiments, the methods 300, 600, 700, 900, and 1000 can be scheduled to run based on one or more predetermined events, and/or can run continuously during operation of the system 100.

In one example, the method 300 of FIG. 3 may be performed by the towing service module 102 to coordinate the towing service. The method 300 may begin at 405. The tow request communicated by the vehicle 104 is received at 410. In various embodiments, the tow request includes an indication of the failure that is causing the request for a tow (e.g., fault codes, etc.), a location of the vehicle, any physical characteristics to identify the vehicle, and/or any time constraints. The tow request is processed at 420 to determine and communicate back to the autonomous vehicle 104 a towing destination and towing types available for that destination at 420. In response, a towing type confirmation is received from the vehicle 104 at 430 and evaluated.

For example, if a limp home mode was confirmed by the vehicle 104 at 440, a sensing kit is selected and deployed at 450. Thereafter, the method may end at 455.

If the limp home mode is not confirmed but aerial tow is confirmed at 460, it is determined whether the aerial tow vehicle 106 can operate in the environment between the vehicle location and the towing destination at 470. When it is determined that the aerial tow vehicle can operate in the environment, it is determined whether a platoon is possible at 480. If a platoon is not possible at 480, an aerial tow vehicle is deployed at 500. Thereafter, the method may end at 455. If a platoon is possible at 480, an aerial platoon is coordinated at 490. Thereafter, the method may end at 455.

When it is determined that the aerial tow vehicle cannot operate in the environment at 470, it is determined whether the tow requires an aerial view at 510. When the tow requires an aerial view at 510, then a communication is sent that indicates autonomous towing is not available at 520. Thereafter, the method may end at 455.

When the tow does not require an aerial view at 510, it is determined if a ground platoon is possible at 530. If a ground platoon is possible at 530, a ground platoon is coordinated at 540. Thereafter, the method may end at 455. If the ground platoon is not possible at 530, the ground vehicle is deployed at 550. Thereafter, the method may end at 455.

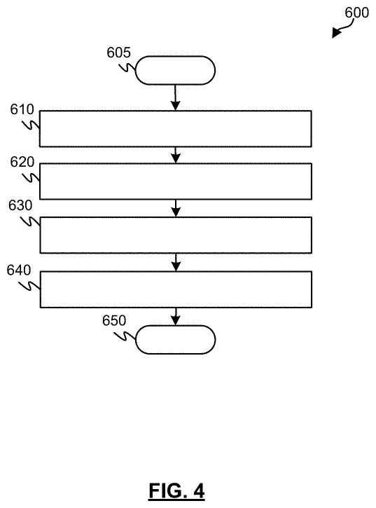

In another example, the method 600 of FIG. 4 may be performed by the towing module 110 to coordinate the towing service. The method 600 may begin at 605. A tow request is transmitted to the towing service module 102 at 610. The towing destination is received and confirmed at 620. The towing options are confirmed by the vehicle at 630 and communicated to the towing service module 102 at 640. Thereafter, the method may end at 650.

In various embodiments, the towing options can be determined and confirmed based on a selection of an optimal towing process, where the optimal towing process is determined based on a weighted average of cost and time is minimized:

$${min}_{\{ Arrial , Ground , SensorKit \}} {C}_{tow} + α {T}_{tow} . Where {T}_{tow} = {T}_{taxi \to host} + {T}_{towTrip} , {C}_{tow} = {C}_{energy} + {β}_{1} {C}_{towTaxi} + {β}_{2} {C}_{senseKit} , {T}_{towtrip} = {D}_{towTrip} / {\overline{V}}_{towTrip} , {D}_{towTrip} : \{ {D}_{path 1} , {D}_{path 2} , {D}_{path 3} , … \} , and \\ {\overline{V}}_{towTrip} : \{ {\overline{V}}_{path 1} , {\overline{V}}_{path 2} , {\overline{V}}_{path 3} , … \} .$$

Where D_{towTrip} represents the tow trip distance that both taxi and host travel together, T_{towTrip} represents the tow trip time, T_{tow} represents the total time of tow process, V̅_{towTrip} represents the tow trip average speed (for each route), C_{tow} represents the total cost of towing process, T_{tax→host} represents the time for taxi or sensor to arrive at host position, C_{towTaxi} represents taxi cost (function of capital cost, weather, etc.), and α, β₁, β₂ represent weight factors to integrate towing preference. In various embodiments, the optimization problem can be computed over different towing options and different routes and weight factors are used to integrate towing preferences include driver preferences.

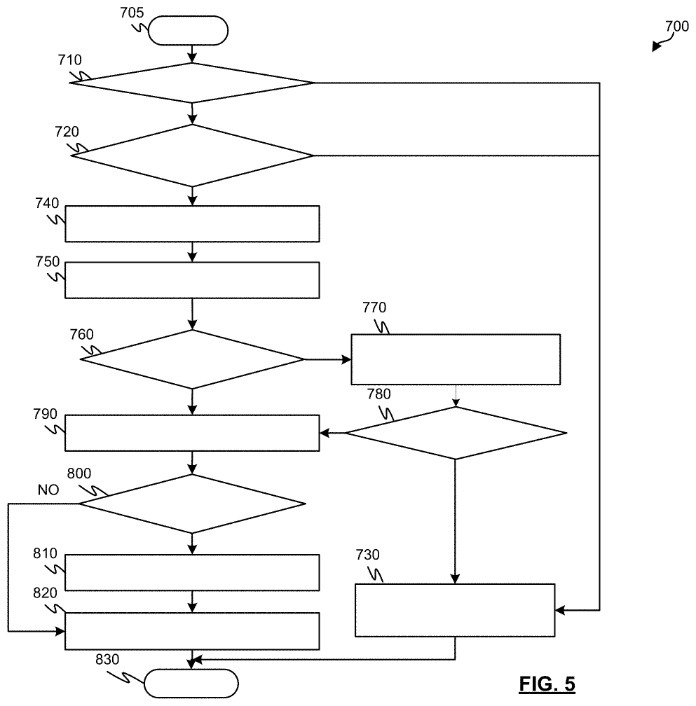

In another example, the method 700 of FIG. 5 may be performed by the towing service module 102, to determine if a platoon is possible. The method 700 may begin at 705. It is determined whether the vehicle accepts platooning at 710. If the vehicle does not accept platooning at 710, it is determined that platooning is not possible at 730 and the method may end at 830. If the vehicle does accept platooning at 710, it is determined whether there is a platoon near and accepting new members at 720. If there is not a platoon nearby or the nearby platoons are not accepting new members at 720, it is determined that platooning is not possible at 730 and the method may end at 830.

If it is determined that a platoon is nearby and accepting new members at 720, a time and path to reach the vehicle 104 is computed for each of the platoon members at 740. The computed time and path is confirmed with each platoon member at 750. If all members do not confirm the time and path at 760, other routes and platoon options are negotiated at 770. If all members do not confirm at 780, it is determined that platooning is not possible at 730 and the method may end at 830. If all members confirm at 760 or 780, the new path is set for the platoon to reach the vehicle at 790. Thereafter, it is determined whether platoon re-ordering is needed to include the vehicle in the platoon at 800. When re-ordering is not needed at 800, the pick-up location, platoon rules, and any other platooning information is communicated to the vehicle at 820. The method may end at 830.

When platoon re-ordering is needed, the new vehicle order is computed and communicated to the platoon members at 810. Thereafter, the pick-up location, platoon rules, and any other platooning information is communicated to the vehicle at 820. The method may end at 830.

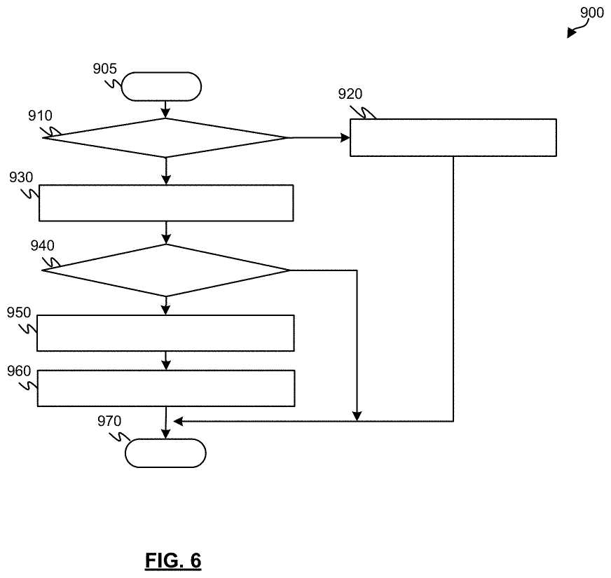

In another example, the method 900 of FIG. 6 may be performed by the towing module 110 of the vehicle 104 to join a platoon. The method 900 may begin at 905. It is determined whether the vehicle accepts platooning at 910. When the vehicle does not accept platooning at 910, it is determined that platoon not possible at 920 and the method may end at 970. If it is determined that the vehicle accepts platooning at 910, any time constraints on the vehicle travel is determined at 930 and communicated to the towing service module 102.

Thereafter, it is determined when platoon information is received at 940. If platoon information is not received at 940, the method may end at 970. If platoon information is received at 940, vehicle is controlled to join the platoon, for example, by establishing the virtual link at 950. A ready command is communicated to the towing vehicle at 960 and the method may end at 970.

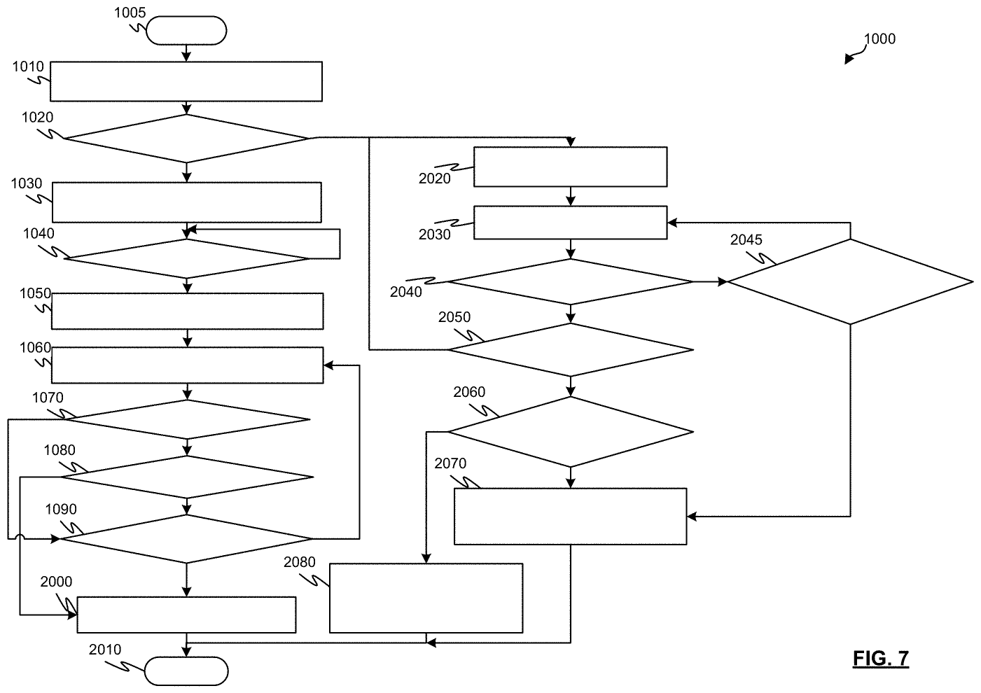

In another example the method 1000 of FIG. 7 may be performed by the towing service module 102 to monitor the towing of the vehicle 104. The method 1000 may begin at 1005. Handshake rules are established at 1010. Thereafter, it is determined if the tow is a platooning tow at 1020. If the tow is a platooning tow at 1020, the coordination is performed, for example, as described above, until the vehicle joins the platoon at 2020. The platoon is then monitored at 2030, for example, by monitoring all vehicles and/or by monitoring the tow vehicle which monitors all vehicles. If a failure is not detected, it is determined whether the vehicles have arrived at their destination at 2045. If the vehicles have not arrived at their destination at 2045, the method 1000 continues to monitor the platoon at 2030. If the vehicles have arrived at 2045, coordination of a vehicle exit and reformation of the platoon is performed at 2070. Thereafter, the method 1000 may end at 2010.

If a failure is detected in one or more vehicles of the platoon at 2040, it is determined whether platoon reformation (e.g., reordering of vehicles or a vehicle leaving a platoon) is possible at 2050. If platoon reformation is possible, the method continues at 2020 with coordinating the platoon. If reformation is not possible at 2050, it is determined whether reformation is possible if a vehicle is removed at 2060. If reformation is possible if a vehicle is removed, coordination of a vehicle exit and reformation of the platoon is performed at 2070. Thereafter, the method 1000 may end at 2010.

If reformation of the platoon is not possible at 2060, towing by the platoon is stopped and other options are coordinated at 2080. Thereafter, the method 1000 may end at 2010.

If, at 1020, the tow is not a platooning tow, the tow vehicle or sensing kit is monitored at 1030. Once the towing has started at 1040, communications are sent to any identified surrounding object to identify the tow at 1050. A towing process status is received at 1060. If the towing process is interrupted at 1070, it is determined whether towing can be restarted at 1080. If the towing process has not been interrupted at 1070 or the towing can be restarted at 1080, it is determined whether the vehicle has arrived at the destination at 1090. If the towing cannot be restarted at 1080 or the host vehicle has arrived at the destination at 1090, stopping of the tow is coordinated at 2000. Thereafter, the method 1000 may end at 2010.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A remote transportation system comprising a first autonomous vehicle, at least one second autonomous vehicle and a remote transportation server, the remote transportation server comprising non-transitory computer readable media and one or more processors configured by programming instructions on the non-transitory computer readable media to:
receive a request for tow service from the first autonomous vehicle, wherein the request includes a location of the first autonomous vehicle;
identify a towing destination for the first autonomous vehicle based on the location of the first autonomous vehicle;
perform an initial fault diagnosis to determine a towing type;
confirm the towing type with the first autonomous vehicle to be at least one of a ground tow, an aerial tow, and a sensor kit tow; and
coordinate towing of the first autonomous vehicle to the towing destination by the at least one second autonomous vehicle based on the towing type.

2. The remote transportation system of claim 1, wherein the towing type is a ground tow platoon.

3. The remote transportation system of claim 1, wherein the towing type is an aerial tow platoon.

4. The remote transportation system of claim 1, wherein the instructions confirm the towing type based on towing options communicated by the first autonomous vehicle.

5. The remote transportation system of claim 1, wherein the instructions confirm the towing type based on a determination of operation of an aerial autonomous vehicle in an environment of the first autonomous vehicle.

6. The remote transportation system of claim 1, wherein the instructions coordinate the towing based on an availability of the at least one second autonomous vehicle.

7. The remote transportation system of claim 1, wherein the instructions are further configured to coordinate the towing of the first autonomous vehicle by the at least one second autonomous vehicle.

8. The remote transportation system of claim 7, wherein the instructions are further configured to coordinate reformation of at least one of a ground tow platoon or an aerial tow platoon based on the monitoring.

9. The remote transportation system of 7, wherein the instructions are further configured to coordinate exit of the first autonomous vehicle from the tow based on the monitoring.

10. The remote transportation system of claim 7, wherein the instructions are further configured to communicate to objects surrounding the first autonomous vehicle an indication of the tow.

11. A method in remote transportation system comprising a first autonomous vehicle, at least one second autonomous vehicle and a remote transportation server, the method comprising:
receiving a request for tow service from the first autonomous vehicle, wherein the request includes a location of the first autonomous vehicle;
identifying a towing destination for the first autonomous vehicle based on the location of the first autonomous vehicle;
performing an initial fault diagnosis to determine a towing type;
confirming the towing type with the first autonomous vehicle to be at least one of a ground tow, an aerial tow, and a sensor kit tow; and
coordinating towing of the first autonomous vehicle to the towing destination by the at least one second autonomous vehicle based on the towing type.

12. The method of claim 11, wherein the towing type is a ground tow platoon.

13. The method of claim 11, wherein the towing type is an aerial tow platoon.

14. The method of claim 11, wherein the confirming the towing type is based on towing options communicated by the first autonomous vehicle.

15. The method of claim 11, wherein the confirming the towing type is based on a determination of operation of an aerial autonomous vehicle in an environment of the first autonomous vehicle.

16. The method of claim 11, wherein the coordinating the towing is based on an availability of the at least one second autonomous vehicle.

17. The method of claim 11, further comprising coordinating the towing of the first autonomous vehicle by the at least one second autonomous vehicle.

18. The method of claim 17, further comprising coordinating reformation of at least one of a ground tow platoon or an aerial tow platoon based on the monitoring.

19. The method of 17, further comprising coordinating exit of the first autonomous vehicle from the tow based on the monitoring.

20. The method of claim 17, further comprising communicating to objects surrounding the first autonomous vehicle an indication of the tow.
